(19) United States
(12) Patent Application Publication
(10) Pub. No.: US 2007/0180259 A1
(43) Pub. Date: Aug. 2, 2007

(54) Secure Personal Medical Process

(76) Inventors: Earl J. Bulot, Baton Rouge, LA (US); Edward M. Scheidt, McLean, VA (US)

Correspondence Address: IP STRATEGIES, 12 1/2 WALL STREET, SUITE I, ASHEVILLE, NC, 28801, US

(21) Appl. No.: 11/625,025

(22) Filed: Jan. 19, 2007

Related U.S. Application Data
(60) Provisional application No. 60/760,623, filed on Jan. 20, 2006.

(51) Int. Cl. H04L 9/00

(52) U.S. Cl. 713/183

(57) ABSTRACT

A process of accessing and controlling medical information data enforced by an encryption process utilizes a split key design. The split key design includes a cryptographic key that is formed from one or more permissions as key splits.

### CROSS REFERENCE TO RELATED APPLICATION

This is related to, and claims the benefit under 35 USC § 119(e) of U.S. Provisional Application for Patent No. 60/760,623, which was filed on Jan. 20, 2006.

### FIELD OF THE INVENTION

The invention relates to secure information access systems. In particular, the invention relates to systems for storing medical information, and secure schemes for authentication and access to the information.

### BACKGROUND OF THE INVENTION

A doctor practicing medicine must be concerned with HIPAA and privacy issues of his/her patients and the liability that extends from handling patient information. In the past, the doctor's process for handling patient information and data was limited to processing of paper. Currently, some of the patient information and data has been transformed into electronic format. More doctors are relying on electronic forms of handling patient information with the eventuality that many, if not all, medical practices will rely on electronic information and data for their patient information. These two parallel events—doctors moving to electronic information and the security concerns surrounding handling this information—set the stage for an electronic secure process that can address security while extending the process across the information flow from the doctor, hospital related, hospital, EMS services, pharmacy, nursing home, home health care, lab, to the patient and other medical providers.

### BRIEF SUMMARY OF THE INVENTION

According to an aspect of the invention, a process of accessing and controlling medical information data enforced by an encryption process utilizes a split key design. The split key design includes a cryptographic key that is formed from one or more permissions as key splits.

The process can also include storing at least a first portion of keying material used in the split key design on a portable memory device and storing at least a second portion of keying material used in the split key design on a viewing device. Preferably, the split key design is compliant with HIPAA regulations.

The encryption process can be performed on a server connected to at least one node.

The encryption process can includes assigning a first permission to a patient, and assigning a second permission to a data viewing device. In this case, the first permission cannot by itself be used to decrypt any data; a combination of the first and second permissions provides access on the data viewing device to data associated with the patient. For example, the first permission can be stored on a token and the second permission can be stored on the data viewing device. The encryption process can also include assigning a third permission to a doctor's office. In this case, a combination of the first and third permissions can provide access to a doctor at the doctor's office to data associated with the patient. In addition, the encryption process can also include assigning a fourth permission to a medical lab, and/or assigning another permission to a pharmacy.

The split key design can include use of a random number in forming the cryptographic key.

### BRIEF DESCRIPTION OF THE DRAWINGS

FIG. 1 is a block diagram showing an exemplary embodiment of a system utilizing the process of the invention.

### DETAILED DESCRIPTION OF THE INVENTION

The secure process includes a mix of a software process application and a hardware token such as a portable memory device. The security policies are enforced through encryption. The encryption process can also be used to restrict changes to patient information or patient data that are enforced through the encryption. HIPAA compliance includes restrictions for modifying data. Also, the memory device would be part of a cryptographic access control and digital signature process to further ensure personal integrity to the patient information. The token would include a microprocessor to manage selective encryption keying material and stored encrypted and unencrypted data. The encryption process is viewed from a central distribution architecture with server or other processor support. An access permission key is created and assigned to each of the principal parties to the medical process, for instance, a permission key for the patient, access key for the doctor, and the same for others. These keys are used as an encryption split so that the combination of selected keys can give the principal party access to a file.

An objective of the medical and encryption processes is to include the patient's presence as one means of accessing a file; whereas, there may be other instances that the doctor or others create private files to which the patient would not normally have access. A further delineation may be that for certain files, the patient may only read the file; whereas, another file may be altered by the patient and require a separate encryption. The encryption process also includes a unique patient number that is applied to the encryption process through a concatenation of the random number that is associated with each encrypting/decrypting event. The patient number is used with all information and data transactions in order to ensure that patient information or data is not separated from the patient's record chain. The purpose of including the unique number with the encryption process is to ensure that the number does not get modified or that the data associated with the number does not get read by someone that is not authorized. The patient number can be, for example, the social security number of the patient.

From the perspective of the patient: a mobile device is needed that can store medical patient information and data in an electronic form that is specific to that patient and provider. A mobile electronic storage device can be a Secure Personal Mobile (SPM) device. By itself, a mobile storage device may be in the form of a token such as an electronic memory device or a mobile processing device that includes memory. The SPM with its electronic storage will have the capacity to store: 1) keying material associated with the authorization encryption process, 2) keying material for an authentication, electronic signature, and 3) encrypted data or encrypted information.

There may be fields stored on the SPM that are in the clear (non-encrypted). Other fields may be encrypted and may include: 1) patient social security number, 2) complete name, 3) a state driver's license number, 4) the patient's picture, 5) diagnostic patient data, patient history, and 6) patient medication.

The SPM is retained by the patient since the data and keying material is private to that person and to those with whom he wants to share information or data. The encrypted information or data contained in the mobile storage device is only related to the patient, a lab, doctor, EMS services, hospital related, hospital, pharmacy, home health care or nursing home. Access to this information or data is available through access permissions associated with the patient's medical interfaces such as the doctor, the lab, pharmacy, nursing home, home health care, EMS services, hospital related or the hospital and those interfaces tied to the encryption keying material. Further access granularity may be needed within a doctor's information practice, and the corresponding encryption process will need to be expanded. For instance, the patient should only have a ‘read’ access; whereas, the doctor, lab, pharmacy, nursing home, home health care, EMS services, hospital related or hospital should have both ‘read’ and ‘write’ access. The patient should not be able to alter his/her information or data, but the doctor and selective others must be able to update the information or data.

The mechanism for defining the permission key process is as follows:

A patient is assigned a permission (P). That permission can be designated as Patient (P1). By itself, Patient (P1) cannot decrypt any data. A second permission is assigned to the device with which the Patient intends to view the data, or Patient Machine (P2). The combination of the two permissions gives the patient access to his/her data. The Patient (P1) may reside on the token; whereas, Patient Machine (P2) can reside on a computing device where the data is viewed. A unique patient number is included with the encryption/decryption process.

From the perspective of the doctor: The doctor or the insurance provider maintains the ownership of the process with a software application that encrypts and decrypts the information or data, and with the distribution of the SPM. The doctor usually has a relationship with a lab for which the process application can be extended. One or more hospitals may also have a process application. The establishment of who should access the medical records would be determined with the doctor and patient, and subsequently the doctor or insurance provider determines where process applications need to be established.

The process application contains the encryption process and interfaces for exchanging the information or data to and from other doctor's office, lab, pharmacy, nursing home, home health care, hospital related, EMS services or hospital electronic medical applications. The different medical entities will probably have different electronic applications that meet their business needs. A process application may be executed on a standalone device such as a personal computer, server, or a mobile processing device such as a tablet PC or PDA.

The secure medical application process may be viewed as an information flow process among the doctor, lab, hospital or hospital related pharmacy, nursing home, home health care, EMS services and patient. The doctor establishes a medical relationship with the patient that results in patient information and associated data. That information and data is formatted and entered into the process application. Assigning electronic access permission(s) and an electronic signature for that patient creates a patient SPM device. The SPM device with its secure encryption capability is used for storing permissions and electronic signatures that are used in the protection of selected patient information or data. (The same process application will be used to encrypt and decrypt patient information or data). The patient is given the SPM device for return visits or visits to a medical lab, pharmacy, nursing home, doctor, home health care or hospital.

The method for defining the permission key process is as follows:

The doctor's office is assigned a Doctor Office permission (P3). The permission (P3) may be used as a general permission key for the whole office, or is combined with the Patient (P1) key for access to that patient's file (the patient brings his token to update his records for the doctor or for himself.) At the doctor's office and during a visit, the patient is asked to input designated information on a computing machine, the output of that data is encrypted against the combination of P1 and P3, and second copy of the data may be encrypted against a new permission combination of P3 and a P4 that is retained at the doctor's office for subsequent notes relating to that patient. A new P5 is created that bridges the doctor to a lab, or a new P6 is created that bridges the doctor to a pharmacy, and a similar sequence is used for other bridging relationships. A unique patient number is included with the encryption/decryption process.

From a lab, pharmacy, or hospital perspective: The same secure medical application process that the doctor used is established at the lab or hospital. The same encryption and decryption process with the optional electronic signature is done. The lab or hospital may want to extend access to the patient's information and data through additional encryption permissions through the application process.

Each entity such as a lab creates a unique permission (P7) for that entity's general use. A further relationship among permissions is established by combining a patient (P1) and (P7) and used when that patient visits the lab. A second encryption may not be need such as with the doctor since the lab only gives the results to the doctor. To remotely transfer data from the lab to a doctor or a hospital, a bridging permission such as (P5) will be needed to transfer and store data. A unique patient number is included with the encryption process.

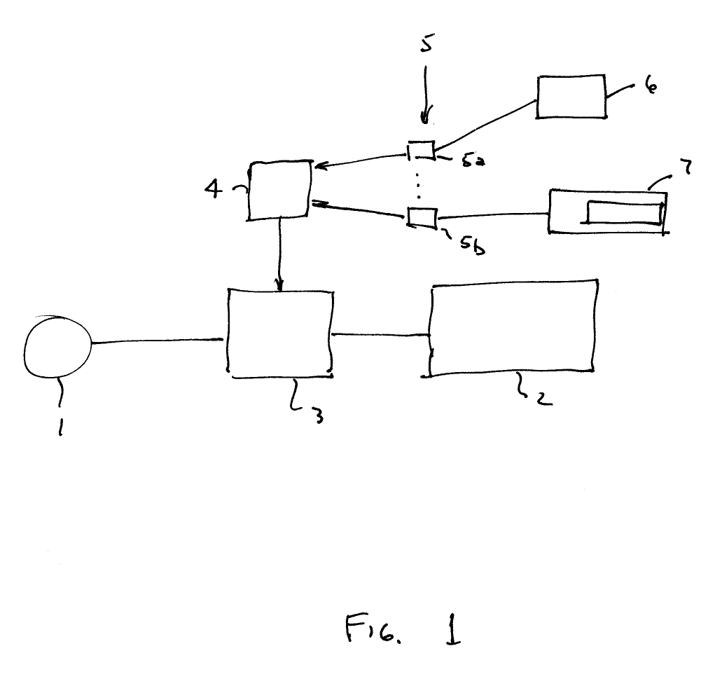

FIG. 1 shows an exemplary general embodiment of a system utilizing the process of the invention. As shown, a user 1 attempts to access medical data 2. Access security is enforced by a cryptographic scheme 3. The scheme requires the use of a key 4, which is formed through the binding or other combination of a number of permissions, or key splits 5. The splits 5 are provided by sources that can be designated to limit access. For example, a first permission 5a can be stored on a physical token 6, and a second permission 5b can be stored on a device 7 that will be used to view the data.

In Summary:
1. A split key design for access and controlling medical information and data.
2. A part of the keying material is stored on a portable memory device and a part of the keying material is stored on a viewing device in order to be compliant with HIPAA regulations.
3. The data encryption process can be at a server. A Machine key such as the above P4 is combined with other keys such as P1 or P3. The split key concept offers a level of privacy to the individual in that the key from the patient's portable memory device would have to be used for their files.
4. A unique patient number is included in the encryption process through a concatenation of the random number that is associated with each encrypting/decrypting event.

The invention is not limited to any particular encryption scheme, and it will be apparent that many standard and proprietary encryption schemes are suitable for application to the process of the invention. For example, the identification, authentication, and encryption schemes disclosed in the following U.S. patents are applicable to the invention, and can be useful in implementing the disclosed processes: U.S. Pat. No. 7,131,009 Multiple factor-based user identification and authentication; U.S. Pat. No. 7,111,173 Encryption process including a biometric unit; U.S. Pat. No. 7,095,852 Cryptographic key split binder for use with tagged data elements; U.S. Pat No. 7,095,851 Voice and data encryption method using a cryptographic key split combiner; U.S. Pat. No. 7,089,417 Cryptographic information and flow control; U.S. Pat. No. 7,079,653 Cryptographic key split binding process and apparatus; U.S. Pat. No. 7,069,448 Context oriented crypto processing on a parallel processor array; U.S. Pat. No. 7,016,495 Multiple level access system; U.S. Pat. No. 6,845,453 Multiple factor-based user identification and authentication; U.S. Pat. No. 6,754,820 Multiple level access system; U.S Pat. No. 6,694,433 XML encryption scheme; U.S. Pat. No. 6,684,330 Cryptographic information and flow control; U.S. Pat. No. 6,608,901 Cryptographic key split combiner; U.S. Pat. No. 6,606,386 Cryptographic key split combiner; U.S. Pat. No. 6,549,623 Cryptographic key split combiner; U.S. Pat. No. 6,542,608 Cryptographic key split combiner; U.S. Pat. No. 6,490,680 Access control and authorization system; U.S. Pat. No. 6,266,417 Cryptographic communication process and apparatus; U.S. Pat. No. 6,229,445 RF identification process and apparatus; U.S. Pat. No. 6,075,865 Cryptographic communication process and apparatus; U.S. Pat. No. 5,898,781 Distributed cryptographic object method; U.S. Pat. No. 5,787,173 Cryptographic key management method and apparatus; U.S. Pat. No. 5,680,452 Distributed cryptographic object method; U.S. Pat. No. 5,432,851 Personal computer access control system; U.S. Pat. No. 5,410,599 Voice and data encryption device; 5,375,169 Cryptographic key management method and apparatus; U.S. Pat. No. 5,369,707 Secure network method and apparatus; U.S. Pat. No. 5,369,702 Distributed cryptographic object method. The disclosures included in these patents are incorporated herein in their entireties.

I claim:

1. A process of accessing and controlling medical information data enforced by an encryption process utilizing a split key design, wherein the split key design includes a cryptographic key that is formed from one or more permissions as key splits.

2. The process of claim 1, further comprising storing at least a first portion of keying material used in the split key design on a portable memory device and storing at least a second portion of keying material used in the split key design on a viewing device.

3. The process of claim 2, wherein the split key design is compliant with HIPAA regulations.

4. The process of claim 1, wherein the encryption process is performed on a server connected to at least one node.

5. The process of claim 1, wherein the encryption process includes
assigning a first permission to a patient, wherein the first permission cannot by itself be used to decrypt any data, and
assigning a second permission to a data viewing device, wherein a combination of the first and second permissions provides access on the data viewing device to data associated with the patient.

6. The process of claim 5, wherein the first permission is stored on a token.

7. The process of claim 5, wherein the second permission is stored on the data viewing device.

8. The process of claim 5, wherein the encryption process further includes assigning a third permission to a doctor's office.

9. The process of claim 8, wherein a combination of the first and third permissions provides access to a doctor at the doctor's office to data associated with the patient.

10. The process of claim 8, wherein the encryption process further includes assigning a fourth permission to a medical lab.

11. The process of claim 8, wherein the encryption process further includes assigning a fourth permission to a pharmacy.

12. The process of claim 1, wherein the split key design includes use of a random number in forming the cryptographic key.
